(19) United States
(12) Patent Application Publication
(10) Pub. No.: US 2024/0051698 A1
(43) Pub. Date: Feb. 15, 2024

(54) OBJECT PROCESSING USING A PLANAR DRIVE SYSTEM

(71) Applicant: BECKHOFF AUTOMATION GMBH, Verl (DE)

(72) Inventors: Felix Schulte, Rietberg (DE); Johannes Beckhoff, Schloß Holte-Stukenbrock (DE); Hans Beckhoff, Verl (DE)

(21) Appl. No.: 18/476,946

(22) Filed: Sep. 28, 2023

Related U.S. Application Data
(63) Continuation of application No. PCT/EP2022/059688, filed on Apr. 12, 2022.

(30) Foreign Application Priority Data
Apr. 12, 2021 (DE) 10 2021 108 987.5

(51) Int. Cl. B65C 9/04; H02P 25/064; H02K 41/03

(52) U.S. Cl. CPC B65C 9/04; H02P 25/064; H02K 41/031; H02K 2201/18

(57) ABSTRACT

A method is provided for processing an object using a planar drive system having at least one stator assembly with a plurality of coil groups for generating a stator magnetic field, a stator surface above the stator assembly, and at least one rotor with a plurality of magnet units for generating a rotor magnetic field. A processing element is arranged above the stator surface. The planar drive system has at least one rotational position, where the rotor can be rotated about an axis perpendicular to the stator surface. A spatial arrangement of the processing element is predetermined by the rotational position. The method comprises energizing the coil groups so a rotor with the object arranged on the rotor moves to the rotational position, energizing the coil groups so the rotor rotates, and processing the object with the aid of the rotor rotation, where the processing element acts upon the object.

### CROSS-REFERENCE TO RELATED APPLICATIONS

This patent application is a continuation of International Application PCT/EP2022/059688, filed Apr. 12, 2022, entitled OBJECT PROCESING USING A PLANAR DRIVE SYSTEM, which claims the priority of German Patent Application DE 10 2021 108 987.5, filed Apr. 12, 2021, entitled OBJEKTBEARBEITUNG MIT EINEM PLANARANTRIEBSSYSTEM, each of which is incorporated by reference herein, in the entirety and for all purposes.

### FIELD

The invention relates to a method for processing an object with the aid of a planar drive system. The invention further relates to a controller for a planar drive system for implementing the method, and to a planar drive system comprising such a controller.

### BACKGROUND

Planar drive systems may be used, among other things, in automation technology, in particular manufacturing technology, handling technology and process engineering. Planar drive systems may be used to move or position a moving element, for example a rotor, of a system or machine in at least two linearly independent directions. Planar drive systems may comprise a permanently energized electromagnetic planar motor with a planar stator and a rotor movable on the stator in at least two directions.

In a permanently energized electromagnetic planar motor, a driving force is exerted on the rotor by the fact that energized coil groups of the stator assembly interact magnetically with driving magnets of a plurality of magnet arrangements of the rotor.

Planar drive systems having rectangular and elongated coil groups and rectangular and elongated magnet units of the rotor are known from the prior art. Such a planar drive system is described, for example, in the disclosure document DE 10 2017 131 304 A1. With the aid of such a planar drive system, linear and translational movement of the rotor is possible in particular. This means that with the aid of such a planar drive system, the rotor may be moved freely in parallel to the stator surface above a stator surface under which the rectangular and elongated coil groups are arranged, and may be moved perpendicular to the stator surface at least at different distances from the stator surface. Furthermore, such a planar drive system is capable of tilting the rotor by a few degrees and rotating it by a few degrees. The latter movements may be carried out above arbitrary positions of the stator surface. In particular, the rotor may be rotated from a normal position by up to 20°. A complete rotation of the rotor is not possible above arbitrary positions of the stator surface.

Planar drive systems with round coil groups are known from the prior art, Proceedings of DSCC2008 2008 ASME Dynamic Systems and Control Conference Oct. 20-22, 2008, Ann Arbor, Michigan, USA. Coil groups having a round embodiment are advantageous for the rotation of the rotor, but have significant disadvantages for the linear translational motion of the rotor and may lead to unsteady and jerky traversing motions.

### SUMMARY

The invention provides a method for processing an object with the aid of a planar drive system in which a rotor rotation is used. The invention provides a controller for the planar drive system, via which the method may be controlled. The invention provides a planar drive system having such a controller.

According to a first aspect, a method for processing an object with the aid of a planar drive system, the planar drive system comprising at least one stator assembly having in each case a plurality of coil groups for generating a stator magnetic field, a stator surface above the stator assembly, and at least one rotor having a plurality of magnet units for generating a rotor magnetic field, wherein a processing element is arranged above the stator surface, wherein the planar drive system comprises at least one rotational position, wherein the rotor may be rotated in the rotational position about an axis of rotation perpendicular to the stator surface, wherein a spatial arrangement of the processing element is predetermined by the rotational position, comprises the following steps: Energizing the coil groups in such a way that the rotor with the object arranged on the rotor moves into the rotational position; energizing the coil groups in such a way that the rotor rotates; processing the object with the aid of the rotor rotation, wherein the processing element acts upon the object.

According to a second aspect, a planar drive system comprises at least one stator assembly each having a plurality of coil groups for generating a stator magnetic field and a stator surface, further comprising at least one rotor having a plurality of magnet units for generating a rotor magnetic field, wherein the rotor may be driven above the stator surface via a magnetic coupling between the stator magnetic field and the rotor magnetic field, wherein the planar drive system further comprises the controller and a processing element, wherein the controller outputs the control commands to the stator assemblies of the planar drive system, the controller being set up to output control signals, the control signals comprising energization information for coil groups of a stator assembly, the coil groups being energized on the basis of the control signals in such a way that the rotor with the object arranged on the rotor moves into the rotational position and then rotates, wherein the processing element acts upon the object when rotating.

### EXAMPLES

A planar drive system comprises at least one stator assembly having a plurality of coil groups for generating a stator magnetic field, a stator surface above the stator assembly, and at least one rotor with a plurality of magnet units for generating a rotor magnetic field. The coil groups may be embodied as rectangular and elongated coil groups. The at least one stator assembly may be embodied in such a way that the plurality of coil groups comprise two mutually different main directions of extension at right angles to each other and the magnet units of the rotor are also arranged at right angles with regard to one another. By energizing the coil groups, the rotor may then be moved above the stator surface in the two main directions of extension. Furthermore, vector-wise superposition of the two movements and thus free positioning of the rotor above the stator surface is also possible.

In this context, as implemented in the planar drive system marketed by the applicant under the name XPLANAR transport system, it may be provided that the stator surface is composed of upper surfaces of a plurality of stator modules and four stator assemblies are provided in each stator module. The planar drive system further comprises a processing element arranged above the stator surface. Furthermore, the planar drive system comprises at least one rotational position, wherein the rotor may be rotated about an axis of rotation perpendicular to the stator surface in the rotational position. A spatial arrangement of the processing element is predetermined by the rotational position. A method for processing an object with the aid of this planar drive system comprises the following steps:
Energizing the coil groups in such a way that the rotor moves to the rotational position with the object arranged on the rotor;
Energizing the coil groups in such a way that the rotor rotates;
Processing of the object with the aid of the rotor rotation, with the processing element acting upon the object.

Due to the spatial arrangement of the processing element specified by the rotational position, it may be achieved that an interaction between the object and the processing element during the rotor rotation leads to the processing of the object. In other words, this means that a spatial arrangement of the processing element is selected with respect to the rotational position. In particular, it may be provided that a plurality of rotational positions are provided above the stator surface, wherein the spatial arrangement of the processing element is predetermined by one of the rotational positions. It may be provided in this context that further movements are carried out by the processing element. In particular, the processing element may be moved in parallel to the stator surface or perpendicularly to the stator surface. If the processing element and the object are to be rotated against each other during processing, it may be provided that this rotation is achieved exclusively by a rotation of the rotor.

This method thus makes it possible to arrange an object to be processed on the rotor and to carry out processing of the object with the aid of the processing element, triggered by the rotor rotation. Such a method allows for flexible processing of the object, since the processing step may not be carried out by each rotor with an object, but only by individual rotors. Overall, the method in which an object is processed with the aid of a rotor rotation and a processing element represents a further possibility for a flexible automation system in which a planar drive system with rotors moving above the stator surface is used to transport the objects. The rotors may be used both for transport and for processing with the aid of rotation, so that a flexible automation system is possible in which objects have to be moved onto or off the rotors as little as possible, since as many processing steps as possible may be carried out with the object positioned on the rotor.

In an embodiment of the method, the rotational position is determined based on a point of contact of four stator assemblies. This may particularly be the case if the rotor also comprises four magnet units and the four stator assemblies and the four magnet units of the rotor may interact in such a way that a center of symmetry of the rotor arranged in the center of the rotor is arranged above the point of contact of the four stator assemblies. In this context, the stator assemblies may be arranged within one or more stator modules that may collectively form the stator surface. For example, if four stator assemblies are arranged within a stator module, the rotational position may be specified by the point of contact of the four stator assemblies within the stator module, but also by points of contact of the stator assemblies of adjacent stator modules, for example in the center of an outer edge of the stator module or at a corner of the stator module.

The position of the processing element is therefore not freely selectable, but in this case depends on the position and embodiment of the stator assemblies. However, the fact that the rotor may be rotated at all rotational positions at which four stator assemblies are in contact still allows an overall flexible arrangement of the planar drive system with a sufficient number of rotational positions for processing the object.

In an embodiment of the method, the processing element and the rotor are moved relative to each other in parallel to the axis of rotation during the rotor rotation. On the one hand, this may be done by moving the rotor towards or away from the processing element during rotation. Furthermore, alternatively or additionally, the processing element may also be moved in parallel to the axis of rotation during the rotor rotation, for example, towards or away from the stator surface. This allows for special processing, such as screwing on a cover, screwing in a screw or processing the object on the rotor with the aid of a laser at different heights.

In an embodiment of the method, the rotor is rotated and the movement of the processing element and the rotor parallel to the axis of rotation relative to each other is carried out in such a way that a first movement and a second movement relative to each other are superimposed for the object arranged on the rotor and the processing element. The first movement is the rotation of the rotor and the second movement is the movement of the rotor and/or of the processing element in parallel to the axis of rotation relative to each other. Such a superimposed movement may also be understood as helical relative to each other. This embodiment is particularly suitable for all screwed connections, since the helical movement during a complete rotation of the rotor may overcome a difference in pitch of a thread and thus a corresponding screwed connection is made.

In an embodiment of the method, the processing element holds a lid for the object. The helical movement relative to each other causes the lid to be screwed to the object. For this purpose, the processing element may comprise a lid holder and the object may e.g. be a bottle or a can. In an automation system, it may be provided, for example, that the bottle or can or generally a container is first filled with a product and then screwed onto a lid by the lid being held by the lid holder above the rotational position and the rotor then rotating with the container below the lid while simultaneously moving towards the lid, overcoming a pitch difference corresponding to a screw thread of the lid during one revolution of the rotor. Alternatively, for example, the lid may be held by the lid holder above the rotational position and then the rotor may be rotated with the container below the lid. Now the lid holder may be moved towards the rotor so that during a rotation of the rotor, a pitch difference corresponding to a screw thread of the lid is overcome. Both variants allow the lid to be screwed onto the container. This may be used advantageously, for example, in a filling line in which the containers are to be filled with a batch size of 1, i.e. individually. The filled containers may then, for example, be placed under different processing elements and, for example, a lid color may signal which product is in the respective container. This allows for an extremely flexible filling system.

It may be provided in this context that the processing element is arranged in such a way that a center of the lid is arranged above the rotational position. A center point of the container may also be arranged in the center of the rotor and thus also concentrically directly below the lid, so that the screw connection may be well executed.

In an embodiment, the rotor has a screw holder. The object on the rotor is a screw. The screw holder holds the screw and inserts the screw into another object held by the processing element with the aid of the helical movement. Thus, the rotor may also be used as a screw holder for screwing screws into objects. The screw holder may be arranged in the center of the rotor for this purpose. Furthermore, it may be provided that the processing element may be moved in parallel to the stator surface and thus a plurality of screw-in positions of the further object may each be equipped with a screw held by a rotor. For this purpose, it may be provided, for example, that after screwing in the screw, the rotor is moved to a screw transfer unit and picks up a further screw there, and meanwhile the processing element moves the further object to another position, the rotor is then moved back to the rotational position and accordingly also screws the further screw into the object. Of course, the further screw may also be screwed into the further object by a further rotor at this position.

In an embodiment of the method, the rotor is moved away from the stator surface during rotation along the axis of rotation. A change in distance of the rotor per revolution depends on a pitch of the screw. Thus, an advantageous screwing system may be achieved. Alternatively, the processing element may be moved towards the rotor in such a way that a change in distance of the processing element from the rotor per rotation depends on a pitch of the screw.

In an embodiment of the method, control commands for energizing the coil groups during the rotational movement are output on the basis of a closed-loop control. The closed-loop control also takes into account torques and/or angular momentum during the helical movement. Furthermore, a maximum torque and/or a maximum angular momentum is specified. In this way, it may be achieved that the screw is screwed to the further object or the cover is screwed to the object with a predetermined angular momentum or a predetermined torque. The torque or the angular momentum may in this context be determined on the basis of the control commands specified for energizing the coil groups and on the basis of the actual currents within the coil groups. In this way, damage to the object when it is screwed to a cover or to the other object when a screw is screwed in may be avoided.

In an embodiment of the method, a rotation of the rotor is stopped when the maximum torque is reached. As already described, the maximum torque is determined via the control system and may thus also be used to stop the rotational movement. This is particularly advantageous when screwing a lid to a container or when screwing in a screw.

In an embodiment, the processing element comprises a labeling element. The labeling element may e.g. be set up to transfer a label to a round object while the round object is rotated past the labeling element with the aid of the rotor. In this case, it may be provided to align the labeling element in height based on a label position on the object. Non-round objects, such as oval or rectangular objects, may also be labeled in this way.

In an embodiment of the method, the labeling element comprises a label roll holder and an unwinding device. The unwinding device transfers a label from the label roll to the object placed on the rotating rotor during the rotation of the rotor.

In an embodiment, the processing element comprises a laser. The laser irradiates a surface of the object, thereby modifying the surface. In particular, the laser may be arranged to engrave a surface of the object with the aid of the laser, for example for a glass bottle or for an object made of metal. In this context, it may be provided that a vertical positioning of the point of incidence of the laser on the object is carried out by a movement of the laser perpendicular to the stator surface or a movement of the laser parallel to the axis of rotation. A horizontal positioning of the point of incidence of the laser on the object may be achieved by rotation of the rotor.

In an embodiment, a laser controller is configured to activate and deactivate the laser based on an activation sequence determined by the rotation of the rotor and a movement of the laser along the axis of rotation and based on image information. The laser is activated and deactivated based on the activation sequence. This allows, for example, an image or graphic to be transferred to the object with the aid of the laser.

In an embodiment, the laser and the rotor are moved in parallel to the axis of rotation relative to each other. This may be achieved either by moving the laser and/or by moving the rotor.

In an embodiment, the processing element has a stirring spatula that is immovable in a perpendicular orientation with regard to the axis of rotation. The stirring spatula is arranged directly above the rotational position. The object comprises a vessel with a liquid. Prior to the rotor rotation, the stirring spatula is moved in parallel to the axis of rotation towards the rotor and thus immersed in the liquid. The stirring spatula is fixed with respect to a rotational position and the rotation of the rotor causes mixing or stirring of the liquid in the vessel.

A controller for a planar drive system comprises a computing unit. The controller is arranged to calculate and output control signals, the control signals comprising energization information for coil groups of one or more stator assemblies. The coil groups are then energized on the basis of the control signals in such a way that the method according to the invention is carried out. In particular, the rotor is moved and set to rotate on the basis of the energization of the coil groups. It may further be provided that a movement of the rotor perpendicular to the stator surface is achieved on the basis of the energization information. Furthermore, the computing unit may additionally be set up to calculate movements for the processing element and to output corresponding control signals to the processing element.

A planar drive system comprises at least one stator assembly each having a plurality of coil groups for generating a stator magnetic field and a stator surface, and further comprising at least one rotor having a plurality of magnet units for generating a rotor magnetic field. The coil groups may be embodied as rectangular and elongated coil groups. The rotor may be driven above the stator surface via a magnetic coupling between the stator magnetic field and the rotor magnetic field. The planar drive system further comprises the controller according to the invention and a processing element, wherein the controller outputs the control commands to the stator assemblies of the planar drive system. In particular, this may also comprise outputting the control commands to a stator module of the planar drive system, and the stator module includes one or more stator assemblies. The stator module may additionally comprise a module controller in which the control commands are implemented with respect to the energization of the coil groups of the stator assembly or stator assemblies.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a planar drive system having a rotor and rotational positions.

FIG. 2 shows a top view of a planar drive system during rotation.

FIG. 3 shows the planar drive system of FIG. 2 in a side view comprising a processing element.

FIG. 4 shows processing of an object using the planar drive system of FIGS. 2 and 3.

FIG. 5 shows the planar drive system of FIGS. 2 to 4 after processing the object.

FIG. 6 shows a side view of a further planar drive system prior to object processing.

FIG. 7 shows a side view of a further planar drive system prior to object processing.

FIG. 8 shows a top view of the planar drive system of FIG. 7 during object processing.

FIG. 9 shows a top view of a further planar drive system during object processing.

FIG. 10 shows a side view of the planar drive system of FIG. 9.

FIG. 11 a side view of a planar drive system prior to object processing.

FIG. 12 shows a side view of the planar drive system of FIG. 11 during object processing.

FIG. 13 shows a side view of a further planar drive system during object processing.

FIG. 14 shows a side view of a further planar drive system during object processing.

### DETAILED DESCRIPTION

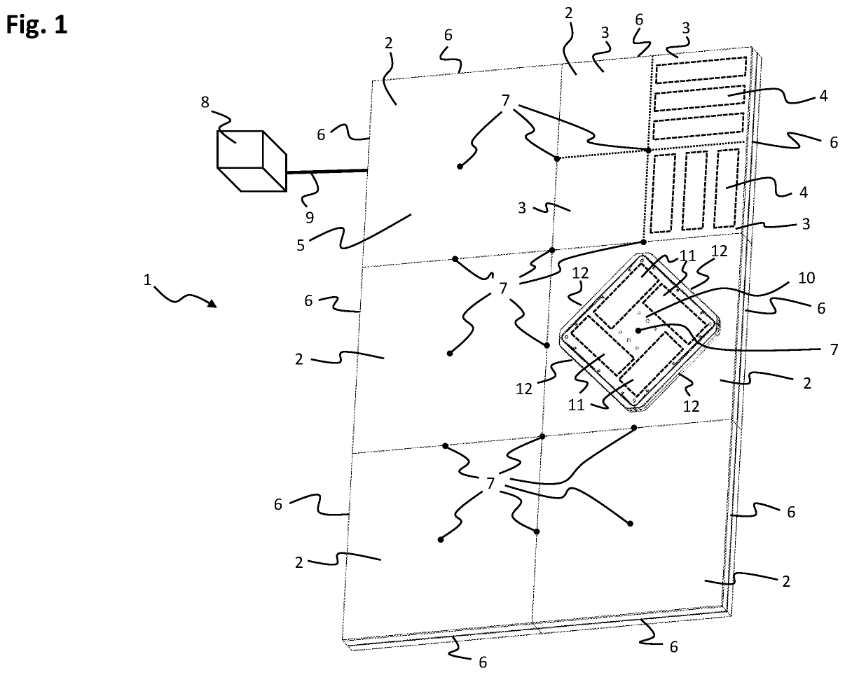

FIG. 1 shows a planar drive system 1 with the aid of which the method according to the invention for processing an object may be carried out. The planar drive system 1 shown in FIG. 1 comprises six stator modules 2, the stator modules 2 being arranged in such a way that a rectangle of two on three stator modules 2 is formed. Other arrangements of the stator modules 2 are also conceivable, and more or fewer than six stator modules 2 may be arranged. In the stator module 2 shown above on the right, an interior of the stator module 2 is indicated, wherein the stator module 2 comprises four stator assemblies 3, the four stator assemblies 3 being arranged within a stator module 2 in a square two-on-two arrangement. Furthermore, for two stator assemblies 3, it is shown that the stator assemblies 3 comprise coil groups 4, wherein the coil groups 4 are shown with different alignments. The coil groups 4 are used to generate a stator magnetic field. In the embodiment shown, the coil groups 4 are rectangular and elongated. In each stator assembly 3 of the stator modules 2, three individual rectangular and elongated coils of a coil group 4 are shown. Likewise, a different number of individual rectangular and elongated coils could form a coil group 4. In this case, their longitudinal extension is oriented in parallel with regard to one of the edges of the respective stator assembly 3. Below each of the depicted coil groups 4, further coils are provided which have an orientation rotated by 90° with respect to their longitudinal extension. This grid of longitudinally extended and rectangular coils of a coil group 4 may be formed one above the other several times. In real terms, neither stator assemblies 3 nor coil groups 4 are visible, since they are surrounded by a housing of the stator module 2. The six stator modules 2 form a continuous stator surface 5 above the stator assemblies 3. Furthermore, a rotor 10 is arranged, the rotor comprising a plurality of magnet units 11 for generating a rotor magnetic field. The coil groups 4 may interact with the magnet units 11 when an appropriate current is applied, thereby moving the rotor 10 above the stator surface 5 within the planar drive system 1. A plane of movement for the rotor 10 is thus defined by the stator surface 5. The coil groups 4 are arranged in parallel to the outer edges 6. Since the stator modules 2 each have outer edges 6 at 900 with regard to one another, two different alignments of the coil groups 4 are therefore necessary for the movement of the rotor 10. The depiction in FIG. 1 is simplified, since in each stator assembly 3 a plurality of coil groups 4 are arranged, which in each case are oriented at 900 with regard to one another, however, only one coil group 4 is depicted in each case. The magnet units 11 are also arranged in parallel with regard to rotor outer edges 12 of the rotor 10. Furthermore, the magnet units 11 are arranged circumferentially within the rotor 10 at the rotor outer edges 12 and may interact with the coil groups 4, respectively, to move the rotor in parallel to the outer edges 6 of the stator modules 2. Furthermore, superposition of two movements parallel to the outer edges 6 is possible, so that the rotor 10 may be moved in all directions in parallel to the stator surface 5. The arrangement of four stator assemblies 3 within a stator module 2 corresponds to the stator modules 2 for a planar drive system 1 marketed by the applicant under the name XPLANAR transport system. It may alternatively be envisaged to arrange more or fewer stator assemblies 3 within a stator module 2. For example, each stator module 2 may comprise only one stator assembly 3 or may comprise more than four stator assemblies 3.

The planar drive system 1 comprises a plurality of rotational positions 7. The rotational positions 7 are always arranged in such a way that four stator assemblies 3 touch each other in the rotational position 7. In particular, this means that corner positions of the stator assemblies 3 define the rotational positions 7 in each case, with the rotational positions 7 always being arranged at the points where four corners of the stator assemblies 3 meet. In particular, this may be in the center of the stator modules 2, in a center of the outer edges 6 of the stator modules 2 or in corner areas of the stator modules 2. Outside of the rotational positions 7, a rotation of the rotor 10 is restricted. Thus, outside of the rotational positions 7, rotors 10 may only be rotated from a resting position up to a predetermined angle, for example 150 or 20°, with the rotor outer edges 12 being in parallel to the outer edges 6 in the resting position. In the rotational positions 7, free rotation of the rotor 10 is possible, and depicted in FIG. 1 by the fact that the rotor has carried out a rotation of 45°. Thus, the alignment of the rotor 10 shown in FIG. 1 is only achievable in a rotational position 7. In FIG. 1, the rotor 10 is located in the center of a stator module 2 and thus also in a rotational position 7.

Also shown in FIG. 1 is a controller 8 and a communication line 9, the controller 9 being connected by the communication line 9 to one of the stator modules 2. It may be provided that the stator modules 2 may forward communication signals to one another. Alternatively, a plurality of communication lines 9 could be provided, in which case each stator module 2 may be connected to the controller 8. The controller 8 is set up to output control commands to the stator modules 2 via the communication line 9, the stator modules 2 being set up to energize the coil groups 4 on the basis of the control signals and thereby to control a movement of the rotor 10 parallel to the stator surface 5 into a rotational position 7 and, when the rotor 10 is arranged in the rotational position 7, to energize the coil groups 4 in such a way that the rotor 10 rotates. The coil groups 4 may further be energized in such a way that the rotor 10 is moved perpendicularly with regard to the stator surface 5.

The planar drive system 1 shown in FIG. 1 may be used in automation technology, in particular in manufacturing technology, handling technology and process engineering, in order to process objects. For example, the objects may be arranged on the rotor 10 or beheld above the stator surface 5 by a holder and processed accordingly by the rotor 10. The fact that the rotor 10 may carry out a rotational movement in the rotational position 7 results in advantageous new embodiments for possible object processing, which will be described in more detail below. For this purpose, it may be provided that a processing element is arranged above the stator surface 5 and a spatial arrangement of the processing element is predetermined by the rotational position 7 in which rotor 10 is to be rotated. An object may be processed with the aid of the rotor rotation, wherein the processing element also acts upon the object. Furthermore, it may be provided that the processing element and the rotor 10 are moved relative to each other in parallel to an axis of rotation during the rotor rotation.

As the case may be, the further figures contain the reference numerals described in connection with FIG. 1. In the further description, as the case may be, these reference numerals will not be discussed furthermore, since the parts of the planar drive system 1 described with these reference numerals were described in connection with FIG. 1.

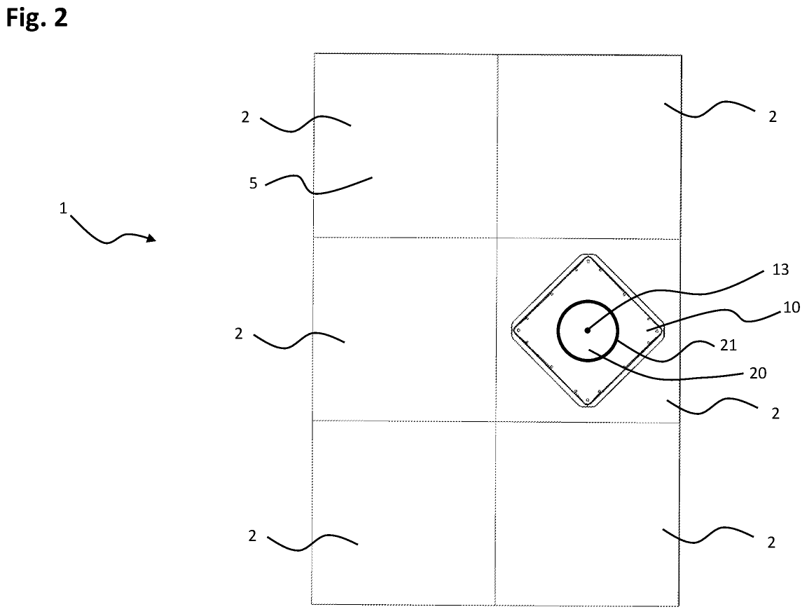

FIG. 2 shows a top view of a planar drive system 1, which is essentially constructed like the planar drive system 1 of FIG. 1. An object 20, in this case a can 21, is arranged on the rotor 10. A rotational axis 13 is perpendicular with regard to the stator surface 5 and is guided by a rotational position 7, in this case in the center of a stator module 2. The rotor 10 may be rotated about the rotational axis 13.

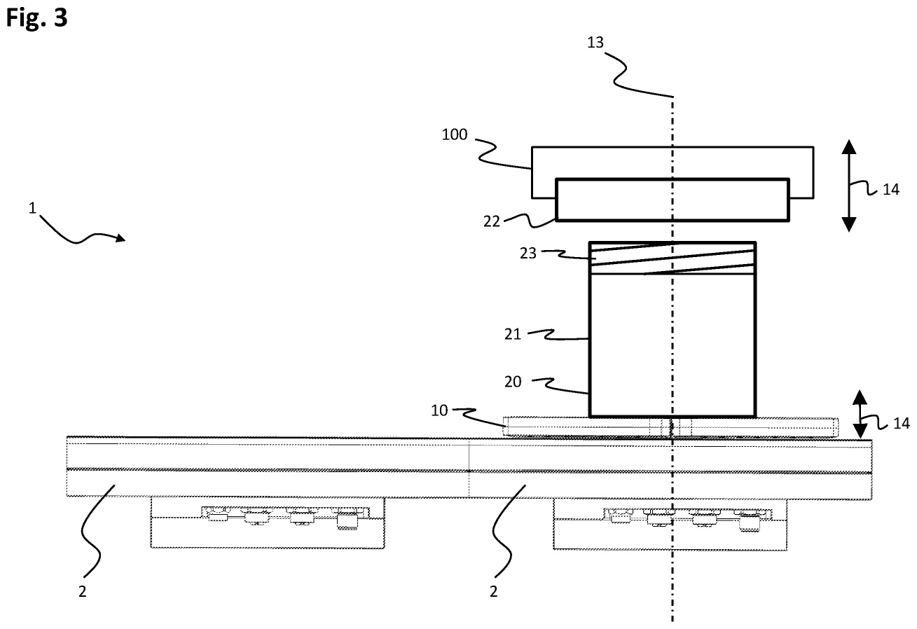

FIG. 3 shows a side view of the planar drive system 1 of FIG. 2. The can 21, i.e. the object 20, is arranged on the rotor 10. Above the object 20, a processing element 100 is shown, which holds a lid 22. The can 21 has a thread 23, with the aid of which the lid 22 may be screwed to the can 21. In order to process the object 20, the rotor 10 is first moved with the aid of energizing the coil groups 4 in such a way that the rotor 10 with the object 20 arranged thereon moves into the rotational position 7. Subsequently, the coil groups 4 are energized in such a way that the rotor 10 rotates. Now the object 20 is processed with the aid of the rotor rotation, with the processing element 100 acting on the object 20. In the embodiment example of FIG. 3, this may be carried out by moving either the rotor 10 and/or the processing element 100 along the direction of movement 14 parallel to the axis of rotation 13 in such a way that the can 21 and the lid 22 move towards each other. The processing by the processing element 100 may thereby comprise, as indicated in the embodiment example of FIGS. 2 and 3, a closing of the can 21 with the aid of the lid 22, in which the lid 22 is screwed onto the thread 23 of the can 21.

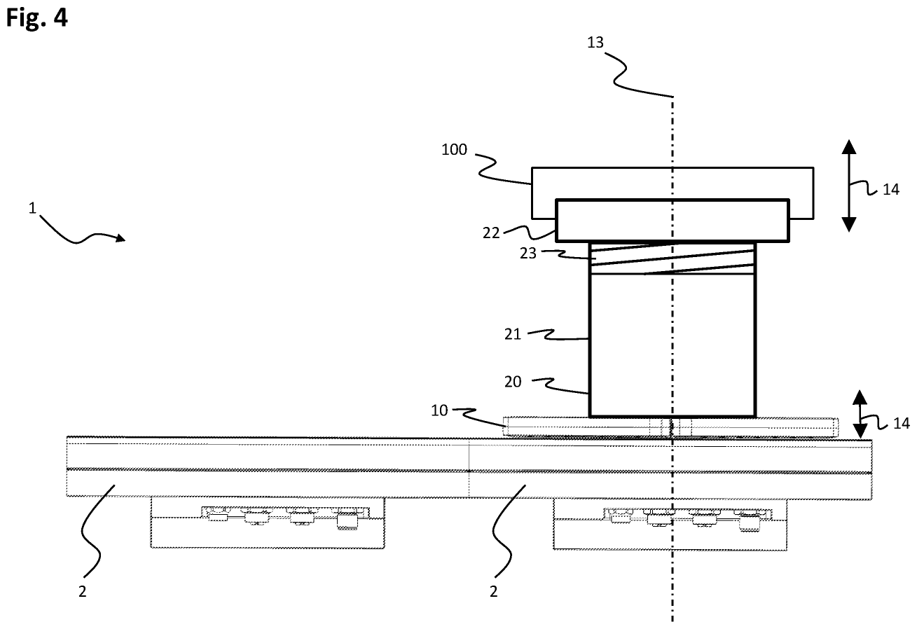

FIG. 4 shows a side view of the planar drive system 1 of FIGS. 2 and 3 after the processing element 100 has been moved slightly towards the rotor 10. The cover 22 is now in close proximity to the thread 23 and may now be screwed to the can 21.

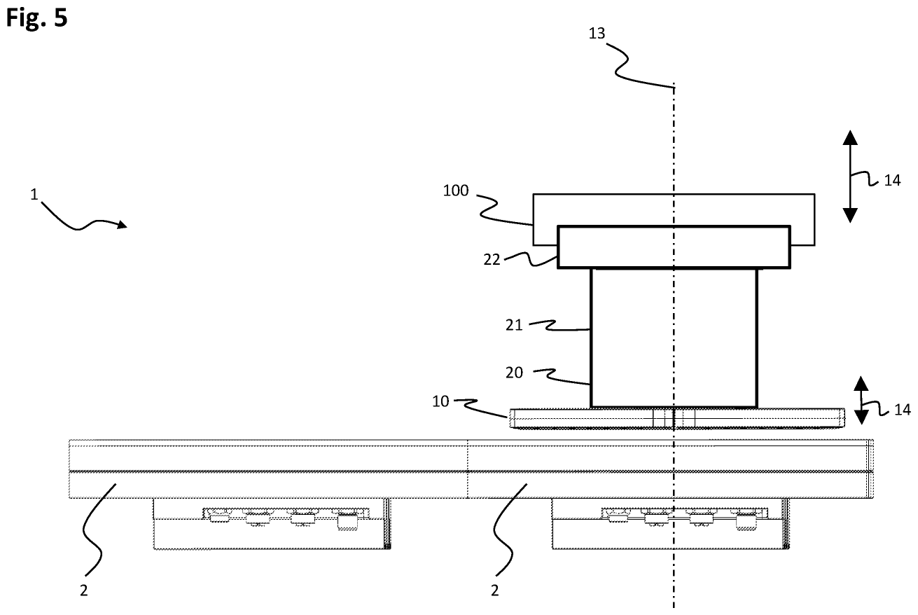

FIG. 5 shows the planar drive system of FIGS. 1 to 4 after the lid 22 has been screwed to the can 21. Here, during the rotation of the rotor 10, the rotor was additionally moved away from the stator surface 5 and the can 21 was rotated into the lid 21 by the rotational movement and the movement away from the stator surface 5.

In the embodiment example of FIGS. 2 to 5, it is shown that the processing element 100 and the rotor 10 may be moved relative to each other in parallel to the axis of rotation 13 during rotor rotation. In particular, the processing element 100 may at first be moved towards the stator surface 5 while the rotor 10 is not yet rotating. In principle, this movement may also be omitted. Subsequently, the rotor 10 is rotated and simultaneously moved away from the stator surface 5 in order to achieve the screwing of the can 21 into the lid 22. Alternatively, instead of moving the rotor 10 away from the stator surface 5, a further movement of the processing element 100 towards the stator surface 5 may also be provided. Additionally, it may be provided that the rotor 10 rotates and is simultaneously moved away from the stator surface 5 while additionally moving the processing element 100 towards the stator surface 5.

In an embodiment, the rotor 10 and the processing element 100 are moved relative to each other in parallel to the axis of rotation 13 in such a way that a first movement and a second movement relative to each other are superimposed for the object 20 arranged on the rotor 10 and the processing element 100. The first movement is rotation of the rotor 10, while the second movement comprises movement of the rotor 10 and/or the processing element 100 relative to each other parallel to the axis of rotation 13. Such movement may be described as helical relative to each other. This allows for the object 20, in this case the can 21, to be easily screwed to the lid 22 held by the processing element 100. A relative change of a distance of the rotor 10 and the processing element 100 with respect to each other during a complete rotation of the rotor 10 thereby depends on a pitch of the thread 23.

In an embodiment, the processing element 100 holds a lid 22 for the object 20, as shown in FIGS. 3 to 5. By superimposing the first movement and the second movement, a screw connection of the lid 22 with the can 21, i.e. with the object 20, takes place. It may be provided that the processing element 100 is arranged in such a way that a center of the lid 22 is arranged above the rotational position 7.

In the embodiment example of FIGS. 2 to 5, instead of the can 21 and the lid 22, it may also be provided that the object 20 comprises a bottle, and a lid 22 is screwed to the object 20, i.e. the bottle, during the rotational movement of the rotor.

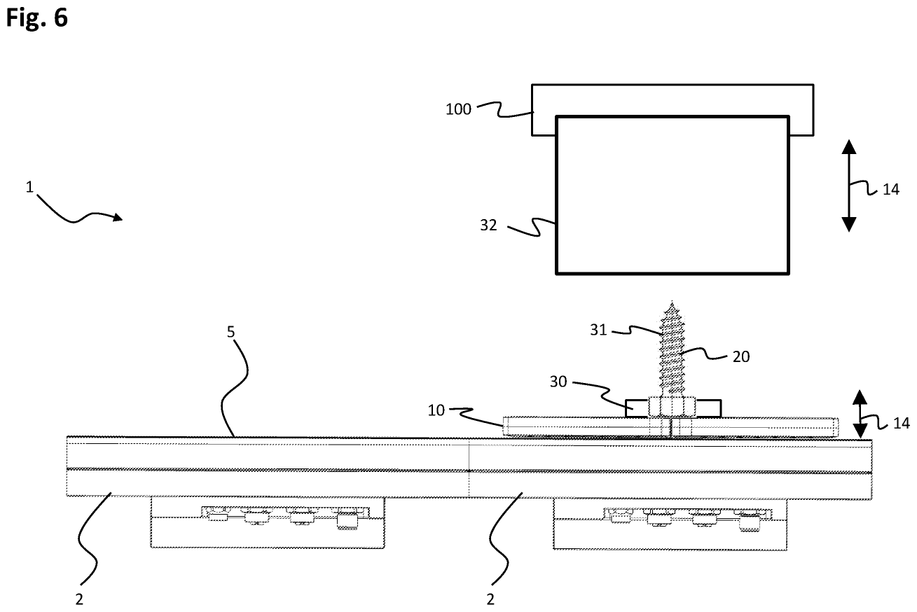

FIG. 6 shows a side view of a further embodiment of a planar drive system 1, in which an object 20 may be processed with the aid of a rotation of a rotor 10. Here, the rotor 10 comprises a screw holder 30 and the object 20 is a screw 31. A further object 32 is held by the processing element 100. Analogous to the screwing of the cover 22 and the can 21 of the embodiment example of FIGS. 2 to 5, in the embodiment example of FIG. 6 the screw 31 may be operated in such a way by the rotation of the rotor 10 and a simultaneous movement of the rotor 10 away from the stator surface 5 or of the processing element 100 towards the stator surface 5 that the screw 31 is screwed into the further object 32. The further object 32 may have a corresponding thread for this purpose. It may be provided in this context that a relative change of a distance of the rotor 10 and the processing element 100 with regard to each other during a complete revolution of the rotor 10 depends on a pitch of the screw 31.

In the embodiment example of FIG. 6, it may be provided that the screw holder 30 with the screw 31 is arranged centrally on the rotor 10. It may further be provided that the processing element 100 may additionally be moved in parallel to the stator surface 5 in order to arrange a thread of the further object 32 above the rotational position 7. In particular, in this embodiment of the method, it may be provided that a plurality of rotors 10 is equipped with screw holders 30 and is accordingly equipped with screws 31. After a screw 31 has been screwed into the further object 32, the corresponding rotor 10 may be moved out from under the further object 32 and a further rotor with a further screw may be positioned at the rotational position 7, the processing element 100 with the further object 32 may be moved in parallel to the stator surface 5 and subsequently the further screw may also be screwed into the further object 32. It may further be provided that the rotor 10 or the further rotor may pick up further screws at a screw transfer unit. In this case, as the case may be, the rotor 10 may also be used to screw in the further screw.

Alternatively, it may be provided that a screw holder 30 with a screw 31 is held by the processing element 100 and the object 20 is arranged on the rotor 10, wherein with the aid of the rotation of the rotor 10 and a movement of the rotor 10 and the processing element 100 relative to each other, the screw 31 is screwed into the object 20.

In the embodiment examples of FIGS. 2 to 6, it may be provided that the movement of the rotor 10 and the processing element 100 relative to each other is also controlled by the controller 8 shown in FIG. 1 and corresponding control commands are output to the stator assembly 2 or the processing element 100. In an embodiment example, these control commands for energizing the coil groups 4 during the rotational movement may be output on the basis of a closed-loop control. With the aid of the closed-loop control, torques and/or angular momentums may further be taken into account during the helical movement, wherein a maximum torque and/or a maximum angular momentum are predetermined. Optionally, it may be provided that a rotation of the rotor 10 is stopped when the maximum torque is reached. In particular, this allows for the lid 22 to be screwed onto the can 21 with a predetermined torque or the screw 31 to be screwed into the further object 32 with a predetermined torque.

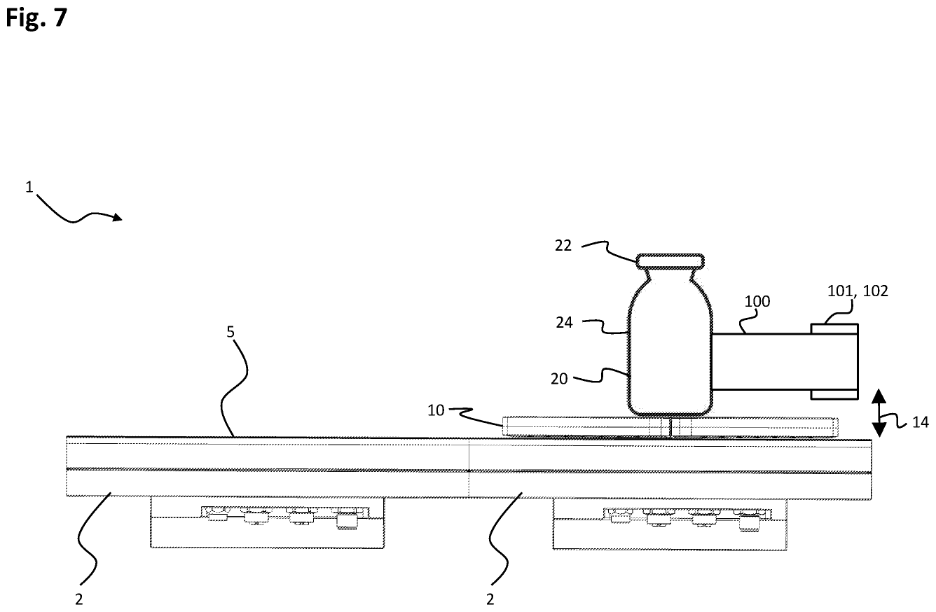

FIG. 7 shows a side view of a further planar drive system 1 in which the processing element 100 comprises a labeling element 101. The object 20 comprises a bottle 24 with a lid 22, and the lid 22 may have been screwed onto the bottle 24 in a manner analogous to the method described in FIGS. 2 to 5. The labeling element 101 is used to apply a label to the bottle 24, or to the object 20. In this regard, it may be provided that a label is transferred from the labeling element 101 to the bottle 24 while the bottle 24 is completely rotated once together with the rotor 10. During the rotation of the rotor 10, a processing of the object 20 by the labeling element 101, i.e. by the processing element 100, takes place by transferring a label onto the bottle 24.

As an alternative to the method shown in FIG. 7, it may also be provided that a label is transferred to a can 21 with the aid of the labeling element 101, wherein the can may be embodied analogously to FIGS. 2 to 5. Furthermore, the can 21 may also comprise an alternative can closure instead of a screw cap, and still be labeled with the aid of the labeling element 21. The same applies in principle to the bottle 24, which may e.g. not be embodied with a lid 22 that may be screwed on, but may likewise have a lid 22 in the form of a crown cork or another closure.

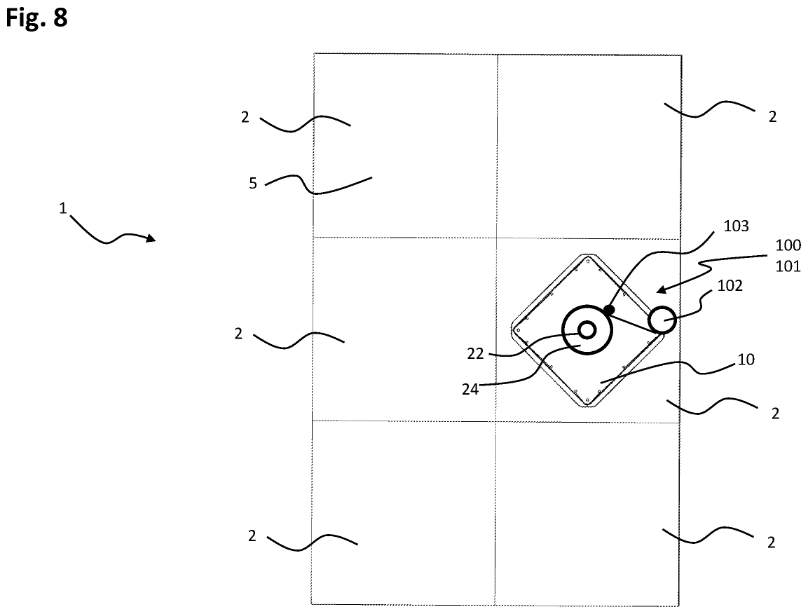

FIG. 8 shows a top view of the planar drive system 1 of FIG. 7. The processing element 100, i.e. the labeling element 101, comprises a label roll holder 102 and an unwinding device 103. A label is transferred from the label roll 102 to the object arranged on the rotating rotor 10, i.e. the bottle 24. This may e.g. be carried out by the unwinding device 103 pressing the label onto the bottle 24, thereby transferring it from the label roll holder 102 to the bottle 24.

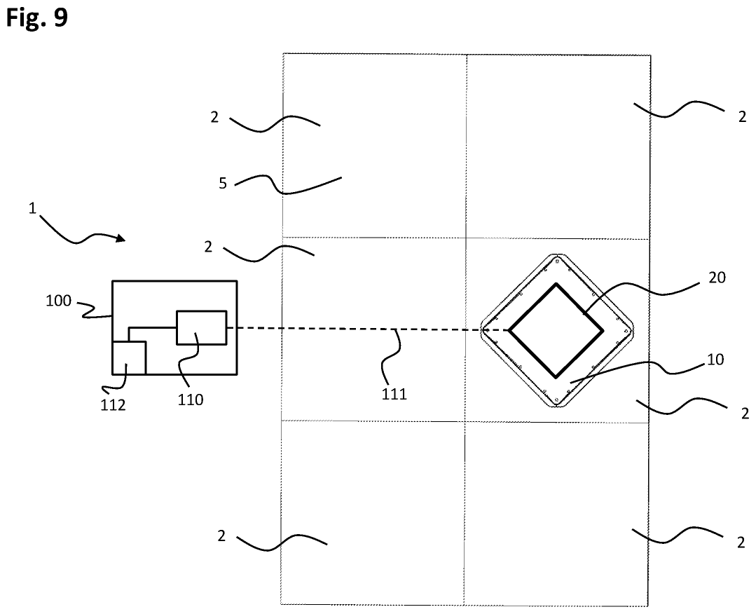

FIG. 9 shows a top view of a further planar drive system 1. In this embodiment, the processing element 100 comprises a laser 110. The laser 110 may irradiate a surface of the object 20 and thereby change it. Thus, a laser radiation 111 emanates from the laser 110 and impinges on the object 20. For example, the laser radiation 111 may be arranged for laser engraving or laser marking of the object 20. The processing element 100 further comprises an optional laser control 112 for activating and deactivating the laser 110.

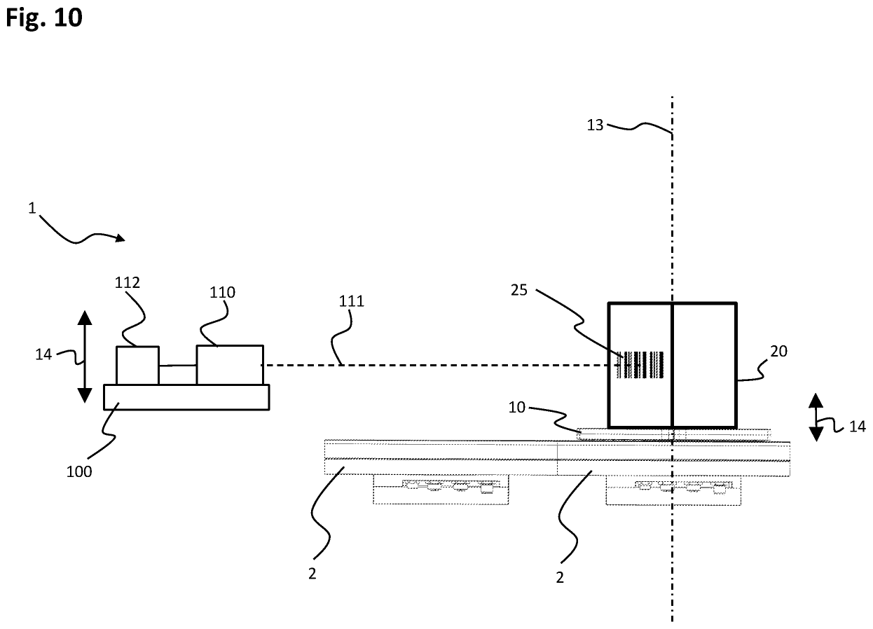

FIG. 10 shows a side view of the planar drive system 1 of FIG. 9, showing that the processing element 100 and/or the rotor 10 may be moved along a direction of movement 14 parallel to the axis of rotation 13. Furthermore, it may be provided that the rotor 10 is tilted so that the axis of rotation 13 is no longer perpendicular to the stator surface 5. With the aid of the laser radiation 111, a barcode 25 is thereby generated on the object 20. In this case, the object 20 is not shown as round, as in the previous embodiment examples. The corresponding generation of the barcode may therefore also be carried out for non-round objects 20. In this case, for each line of the barcode 25, the rotor 10 and/or the processing element 100 is moved in parallel to the axis of rotation 13, and after completion of each line of the barcode 25, the object 20 is further rotated. Alternatively, it may be provided that object is completely rotated once while the laser 110 is turned on and off by the laser control 112, generating one line of barcode at a time. This corresponds to an embodiment example in which the laser control 112 of the laser 110 is arranged to activate and deactivate the laser 110, wherein an activation sequence is determined based on information obtained by the rotation of the rotor 10 and a movement of the laser along the rotational axis 13 and image information, and the laser 110 is activated and deactivated based on the activation sequence. This provides an efficient method for laser marking or laser engraving of the object 20.

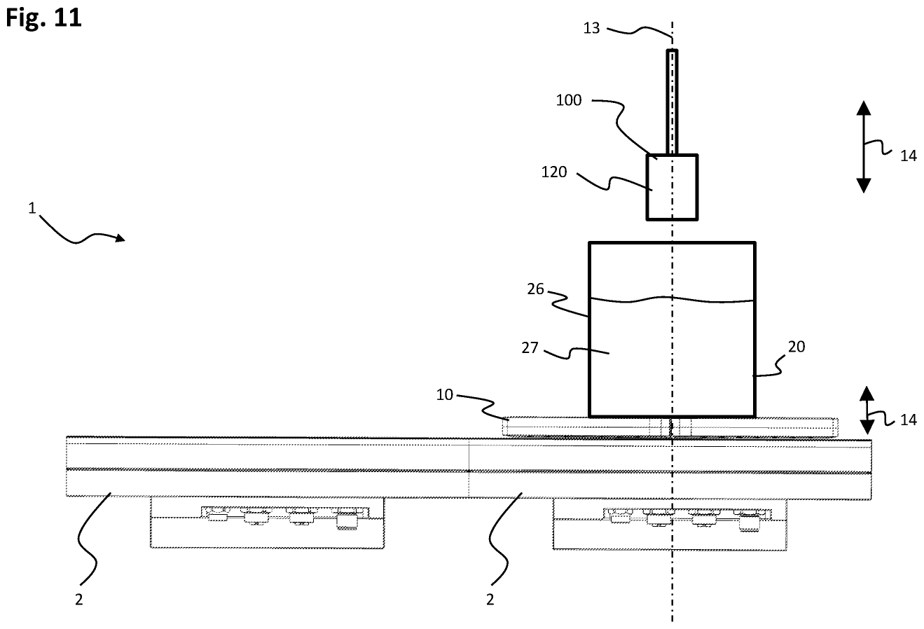

FIG. 11 shows a side view of a further planar drive system 1 for processing an object 20. In this embodiment, the object 20 comprises a vessel 26 with a liquid 27. The processing element 100 comprises a stirring spatula 120, which is immovable in a perpendicular direction with regard to the axis of rotation 13 and is arranged directly above the rotational position 7. In parallel to the axis of rotation 13, the stirring spatula 120 may be moved along the direction of movement 14 and immersed in the liquid 27. FIG. 11 shows the stirring spatula 120 above the vessel 26, with the rotor 10 already moved to the rotational position 7, but not yet rotated.

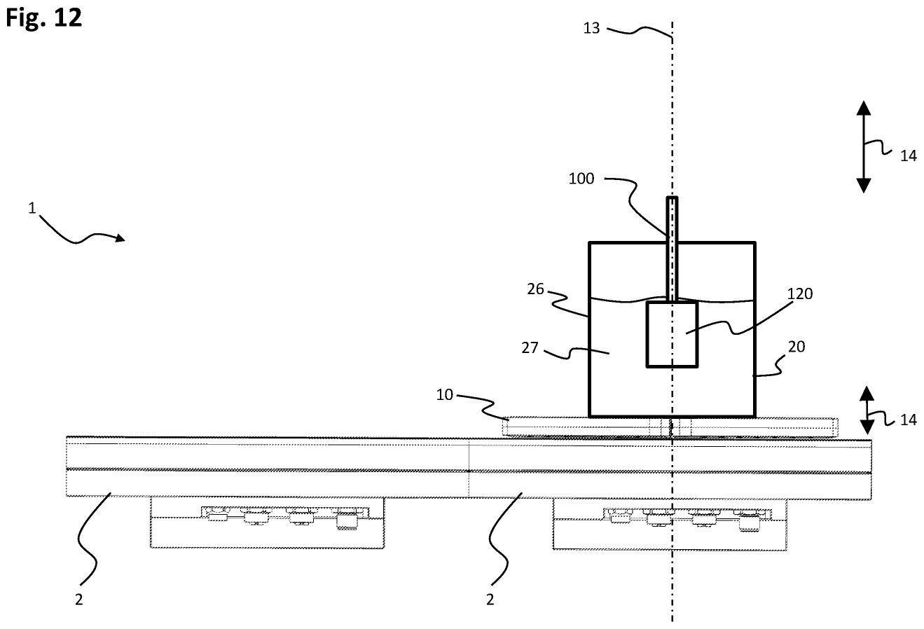

FIG. 12 shows a side view of the planar drive system 1 of FIG. 11, after the stirring spatula 120 has been immersed in the liquid 27 and a rotation of the rotor 10 has been started. Due to the position of the stirring spatula 120 in the liquid 27, a processing of the liquid 27 may be carried out with the aid of the rotor rotation by stirring the liquid 27 with the aid of the stirring spatula 120.

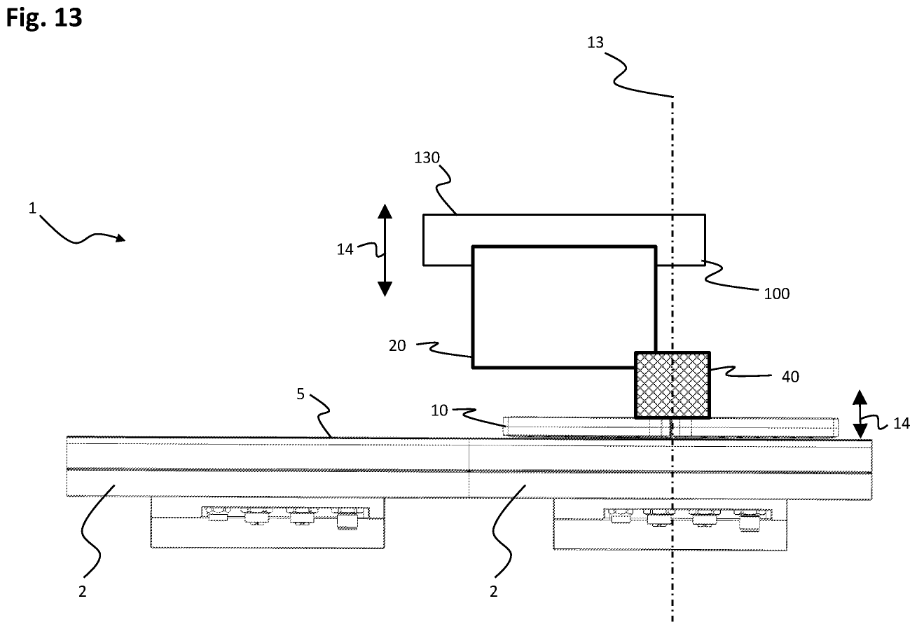

FIG. 13 shows a side view of a further planar drive system 1 for processing an object 20. A milling head 40 is arranged on the rotor 10. The processing element 100 holds the object 20 with the aid of an object holder 130. The rotor 10 may be rotated about the rotational axis 13 in a rotational position 7, as previously described. As a result, the milling head 40 rotates, as well, wherein milling of the object 20 is possible with the aid of the milling head 40. Thereby, a rotational speed of the rotor 10 may be controlled. The processing element 100 may be moved in parallel and perpendicular with regard to the stator surface 5, as a result of which various milling patterns may be generated.

Furthermore, the rotor 10 may also be tilted from the vertical so that the axis of rotation 13 is no longer perpendicular to the stator surface 5. This allows for milling patterns with angled milling edges.

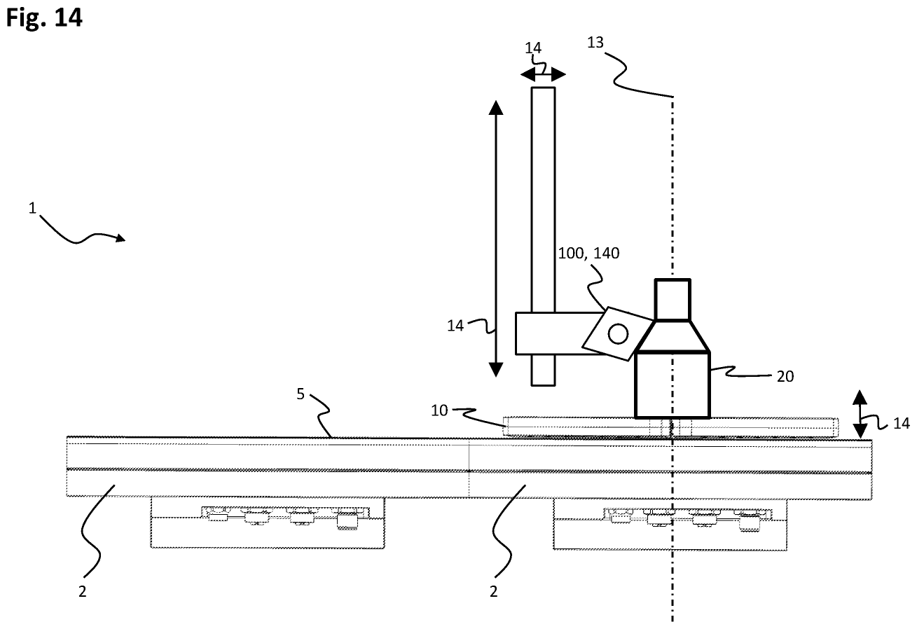

FIG. 14 shows a side view of a further planar drive system 1 for processing an object 20. The object 20 is arranged on the rotor 10. A processing element 100 is configured as a cutting tool 140, for example as a turning tool. The processing tool 140 may be moved in parallel and perpendicular with regard to the stator surface 5. By rotating the rotor 10, the object 20 may be processed as on a lathe when the processing tool 140 is brought into contact with the object 20.

What is claimed is:

1. A method for processing an object using a planar drive system, the planar drive system comprising:
at least one stator assembly having in each case a plurality of coil groups for generating a stator magnetic field,
a stator surface above the stator assembly, and
at least one rotor having a plurality of magnet units for generating a rotor magnetic field;
wherein a processing element is arranged above the stator surface,
wherein the planar drive system comprises at least one rotational position,
wherein the rotor is rotatable in the rotational position about an axis of rotation perpendicular to the stator surface, and
wherein a spatial arrangement of the processing element is predetermined by the rotational position;
the method comprising the following steps:
energizing the coil groups in such a way that a rotor of said at least one rotor with the object arranged on the rotor moves into the rotational position,
energizing the coil groups in such a way that the rotor rotates, and
processing the object with aid of rotation of the rotor, wherein the processing element acts upon the object.

2. The method according to claim 1, wherein the rotational position is determined based on a point of contact of four stator assemblies.

3. The method according to claim 1, wherein during rotor rotation the processing element and the rotor are moved relative to each other in parallel to the axis of rotation.

4. The method according to claim 3, wherein the rotor is rotated and the movement of the processing element and the rotor in parallel to the axis of rotation relative to each other is carried out in such a way that a first movement and a second movement relative to each other are superimposed for the object disposed on the rotor and the processing element.

5. The method according to claim 4, wherein the processing element holds a cover for the object, and wherein the superimposed first movement and second movement cause the cover to be screwed to the object.

6. The method according to claim 4, wherein the processing element is arranged in such a way that a center of the cover is arranged above the rotational position.

7. The method according to claim 4, wherein the rotor rotates and the processing element moves towards the rotor.

8. The method according to claim 4, wherein the rotor comprises a screw holder, the object being a screw, the screw holder holding the screw and screwing it into a further object held by the processing element with aid of the superimposed first movement and second movement.

9. The method according to claim 8, wherein the rotor is moved away from the stator surface during the rotational movement along the rotational axis, wherein a change in distance of the rotor per rotation depends on a pitch of the screw.

10. The method according to claim 4, wherein control commands for energizing the coil groups during the rotational movement are output on the basis of a closed-loop control, and wherein, on the basis of the closed-loop control, torques and/or angular momentums are furthermore taken into account during the superimposed first motion and second motion, wherein a maximum torque or a maximum angular momentum are predetermined.

11. The method according to claim 10, wherein rotation of the rotor is stopped upon reaching the maximum torque.

12. The method according to claim 1, wherein the processing element comprises a labeling element.

13. The method according to claim 12, wherein the labeling element comprises a label roll holder, wherein the labeling element comprises an unwinding device at which a label is transferred from the label roll holder to the object arranged on the rotating rotor.

14. The method according to claim 1, wherein the processing element comprises a laser, wherein the laser irradiates and thereby alters a surface of the object.

15. The method according to claim 13, wherein a laser controller of the laser is arranged to activate and deactivate the laser, wherein an activation sequence is determined based on information provided by the rotation of the rotor and a movement of the laser along the rotational axis and image information, and the laser is activated and deactivated based on the activation sequence, wherein the laser and the rotor are moved relative to each other in parallel to the axis of rotation.

16. The method according to claim 1, wherein the processing element comprises a stirring spatula immovable perpendicular to the rotational axis, the stirring spatula being arranged directly above the rotational position, wherein the object comprises a vessel with a liquid, wherein prior to the rotor rotation the stirring spatula is moved in parallel to the rotational axis and immersed in the liquid.

17. A planar drive system, comprising:
at least one stator assembly, each having a plurality of coil groups for generating a stator magnetic field and a stator surface, and
further comprising at least one rotor having a plurality of magnet units for generating a rotor magnetic field, wherein the rotor is drivable above the stator surface via a magnetic coupling between the stator magnetic field and the rotor magnetic field;
wherein the planar drive system further comprises a controller and a processing element,
wherein the controller outputs control commands to the at least one stator assembly of the planar drive system,
the controller being configured to output control signals, the control signals comprising energization information for the coil groups of the stator assembly, the coil groups being energized on the basis of the control signals in such a way that a rotor of said at least one rotor having an object arranged on the rotor moves into a rotational position and then rotates,
wherein the processing element acts upon the object when rotating.

18. The planar drive system according to claim 17, wherein the processing element comprises a labeling element, wherein the labeling element comprises a label roll holder, wherein the labeling element comprises an unwinding device at which a label is transferred from the label roll holder to the object arranged on the rotating rotor.

19. The planar drive system according to claim 17, wherein the processing element comprises a laser, wherein the laser irradiates and thereby alters a surface of the object wherein a laser controller of the laser is arranged to activate and deactivate the laser, wherein an activation sequence is determined based on information provided by the rotation of the rotor and a movement of the laser along the rotational axis and image information, and the laser is activated and deactivated based on the activation sequence, wherein the laser and the rotor are moved relative to each other in parallel to the axis of rotation.

20. The planar drive system according to claim 17, wherein the processing element comprises a stirring spatula immovable perpendicular to the rotational axis, the stirring spatula being arranged directly above the rotational position, wherein the object comprises a vessel with a liquid, wherein prior to the rotor rotation the stirring spatula is moved in parallel to the rotational axis and immersed in the liquid.
